(19) United States
(12) Patent Application Publication
(10) Pub. No.: US 2014/0044462 A1
(43) Pub. Date: Feb. 13, 2014

(54) COOLING DEVICE, IMAGE FORMING APPARATUS INCLUDING SAME, AND COOLING METHOD

(71) Applicants: Keisuke IKEDA, Kanagawa (JP); Tomoyasu HIRASAWA, Kanagawa (JP); Kenichi TAKEHARA, Kanagawa (JP); Hiromitsu FUJIYA, Kanagawa (JP); Keisuke YUASA, Kanagawa (JP); Yasuaki TODA, Kanagawa (JP)

(72) Inventors: Keisuke IKEDA, Kanagawa (JP); Tomoyasu HIRASAWA, Kanagawa (JP); Kenichi TAKEHARA, Kanagawa (JP); Hiromitsu FUJIYA, Kanagawa (JP); Keisuke YUASA, Kanagawa (JP); Yasuaki TODA, Kanagawa (JP)

(73) Assignee: RICOH COMPANY, LTD., Tokyo (JP)

(21) Appl. No.: 13/950,332

(22) Filed: Jul. 25, 2013

(30) Foreign Application Priority Data
Aug. 10, 2012 (JP) 2012-178292

(51) Int. Cl. G03G 15/20

(52) U.S. Cl. CPC G03G 15/2017
USPC 399/341

(57) ABSTRACT

A cooling device for use in an image forming apparatus, disposed downstream within the apparatus in a direction of conveyance of a sheet from a fixing device that fixes an image onto the sheet at a temperature corresponding to a sheet type, includes a conveyance part to convey the sheet, a cooling member to absorb heat by thermal conduction from the sheet being conveyed by the conveyance part, a temperature controller to control a temperature of the cooling member, a temperature detector to detect the temperature of the cooling member, and a control unit connected to the temperature controller and the temperature detector to control the cooling member, using the temperature controller, to a target temperature corresponding to the sheet type based on the temperature of the cooling member detected by the temperature detector.

### CROSS-REFERENCE TO RELATED APPLICATION

This patent application is based on and claims priority pursuant to 35 U.S.C. §119 to Japanese Patent Application No. 2012-178292, filed on Aug. 10, 2012, in the Japan Patent Office, the entire disclosure of which is hereby incorporated by reference herein.

### BACKGROUND

1. Technical Field

Exemplary aspects of the present invention generally relate to a cooling device included in an image forming apparatus such as a printer, a facsimile machine, and a copier, an image forming apparatus including the cooling device, and a cooling method.

2. Related Art

Related-art image forming apparatuses, such as copiers, printers, facsimile machines, and multifunction devices having two or more of copying, printing, and facsimile functions, typically form a toner image on a recording medium (e.g., a sheet of paper, etc.) according to image data using an electrophotographic method. In such a method, for example, a charger charges a surface of an image carrier (e.g., a photoconductor); an irradiating device emits a light beam onto the charged surface of the photoconductor to form an electrostatic latent image on the photoconductor according to the image data; a developing device develops the electrostatic latent image with a developer (e.g., toner) to form a toner image on the photoconductor; a transfer device transfers the toner image formed on the photoconductor onto a sheet of recording media; and a fixing device applies heat and pressure to the sheet bearing the toner image to fix the toner image onto the sheet. The sheet bearing the fixed toner image is then discharged from the image forming apparatus.

The image forming apparatuses often further include a cooling device including a cooling member that directly or indirectly contacts the sheet heated by the fixing device to cool the sheet.

An example of a related-art cooling device includes a cooling part with controllable cooling capabilities to cool the sheet discharged from the fixing device and a control unit that controls the cooling capabilities of the cooling part to control a temperature gradient of the sheet discharged from the fixing device. The related-art cooling device further includes a temperature detector that detects a temperature of the sheet discharged from the fixing device. The control unit controls the cooling part to provide a cooling capability suitable for each sheet to be cooled based on the temperature of the sheet thus detected by the temperature detector. Such a configuration gives a desired temperature gradient to the sheet, resulting in a toner image with desired glossiness. In addition, cooling of the sheet discharged from the fixing device prevents multiple sheets stacked one atop the other on a discharge tray after being discharged from the fixing device from sticking together with toner of toner images soften by the heat applied by the fixing device (i.e., blocking).

In general, a fixing temperature for fixing the toner image onto the sheet is set for each sheet type, and thus a sheet of a different type has a different temperature after the toner image is fixed onto the sheet by the fixing device. In other words, the cooling required of the cooling part differs depending on the sheet type. For this reason, in general, the temperature detector directly detects a temperature of the sheet discharged from the fixing device and the control unit controls the cooling capability of the cooling part based on the temperature thus detected.

However, use of a contact-type temperature detector that contacts the sheet while the sheet is being conveyed to measure the temperature of the sheet causes friction between the temperature detector and the sheet that damages the toner image formed on the sheet, thereby degrading image quality. In particular, because the sheet discharged from the fixing device is heated and thus the toner has not hardened completely, the toner image is easily damaged.

It is possible to use a contactless-type temperature detector disposed opposite the sheet across a predetermined gap. However, evaporation of moisture from the sheet heated by the fixing device generates steam that can fog the lens of the contactless-type temperature detector, thereby hindering precise measurement of the temperature of the sheet. As a result, control of the cooling part to a temperature suitable for cooling the sheet is not possible.

### SUMMARY

In view of the foregoing, illustrative embodiments of the present invention provide a novel cooling device that controls a cooling member to a temperature suitable for cooling a sheet without damage to a toner image formed on the sheet and deterioration in temperature measurement accuracy. Illustrative embodiments of the present invention further provide an image forming apparatus including the cooling device, and a cooling method.

In one illustrative embodiment, a cooling device for use in an image forming apparatus, disposed downstream within the apparatus in a direction of conveyance of a sheet from a fixing device that fixes an image onto the sheet at a temperature corresponding to a sheet type, includes a conveyance part to convey the sheet, a cooling member to absorb heat by thermal conduction from the sheet being conveyed by the conveyance part, a temperature controller to control a temperature of the cooling member, a temperature detector to detect the temperature of the cooling member, and a control unit connected to the temperature controller and the temperature detector to control the cooling member, using the temperature controller, to a target temperature corresponding to the sheet type based on the temperature of the cooling member detected by the temperature detector.

In another illustrative embodiment, an image forming apparatus includes an image forming unit to form a toner image on a sheet, a fixing device to fix the tone image onto the sheet using at least heat, and the cooling device described above.

In yet another illustrative embodiment, a method of cooling a sheet in an image forming apparatus includes steps of conveying a sheet having an image fixed thereonto at a temperature corresponding to a sheet type, absorbing heat, using a cooling member, from the sheet being conveyed, controlling a temperature of the cooling member, detecting the temperature of the cooling member, and controlling the cooling member to a target temperature corresponding to the sheet type based on the temperature of the cooling member detected by the detecting.

Additional features and advantages of the present disclosure will become more fully apparent from the following detailed description of illustrative embodiments, the accompanying drawings, and the associated claims.

### BRIEF DESCRIPTION OF THE DRAWINGS

A more complete appreciation of the disclosure and many of the attendant advantages thereof will be more readily obtained as the same becomes better understood by reference to the following detailed description of illustrative embodiments when considered in connection with the accompanying drawings, wherein:

FIG. 1 is a schematic vertical cross-sectional view illustrating an example of a configuration of an image forming apparatus according to illustrative embodiments;

FIG. 2 is a perspective view illustrating an example of a configuration of a cooling device according to a first illustrative embodiment;

FIG. 3 is a schematic view of the cooling device according to the first illustrative embodiment;

FIG. 4 is a schematic view illustrating an example of a configuration of a related-art contact-type temperature detector;

FIG. 5 is a schematic view illustrating an example of a configuration of a related-art contactless-type temperature detector;

FIG. 6 is a flowchart illustrating steps in a process of controlling a temperature of an air-cooling heat sink included in the cooling device according to the first illustrative embodiment;

FIG. 7 is a graph showing a relation between a temperature of an air-cooling heat sink and an operating time of an image forming apparatus according to a second illustrative embodiment;

FIG. 8 is a flowchart illustrating steps in a process of controlling the temperature of the air-cooling heat sink included in a cooling device according to the second illustrative embodiment;

FIG. 9 is a schematic view illustrating an example of a configuration of a cooling device according to a third illustrative embodiment;

FIG. 10 is a flowchart illustrating steps in a process of controlling a temperature of a liquid-cooling plate included in the cooling device according to the third illustrative embodiment;

FIG. 11 is a schematic view illustrating an example of a configuration of a cooling device according to a fourth illustrative embodiment;

FIG. 12 is a schematic view illustrating an example of a configuration of a heat pipe roller included in the cooling device according to the fourth illustrative embodiment; and

FIG. 13 is a schematic view illustrating an example of a configuration of a cooling device according to a fifth illustrative embodiment.

### DETAILED DESCRIPTION

In describing illustrative embodiments illustrated in the drawings, specific terminology is employed for the sake of clarity. However, the disclosure of this patent specification is not intended to be limited to the specific terminology so selected, and it is to be understood that each specific element includes all technical equivalents that have substantially the same function, operate in a similar manner, and achieve a similar result.

Illustrative embodiments of the present invention are now described below with reference to the accompanying drawings. In a later-described comparative example, illustrative embodiment, and exemplary variation, for the sake of simplicity the same reference numerals will be given to identical constituent elements such as parts and materials having the same functions, and redundant descriptions thereof omitted unless otherwise required.

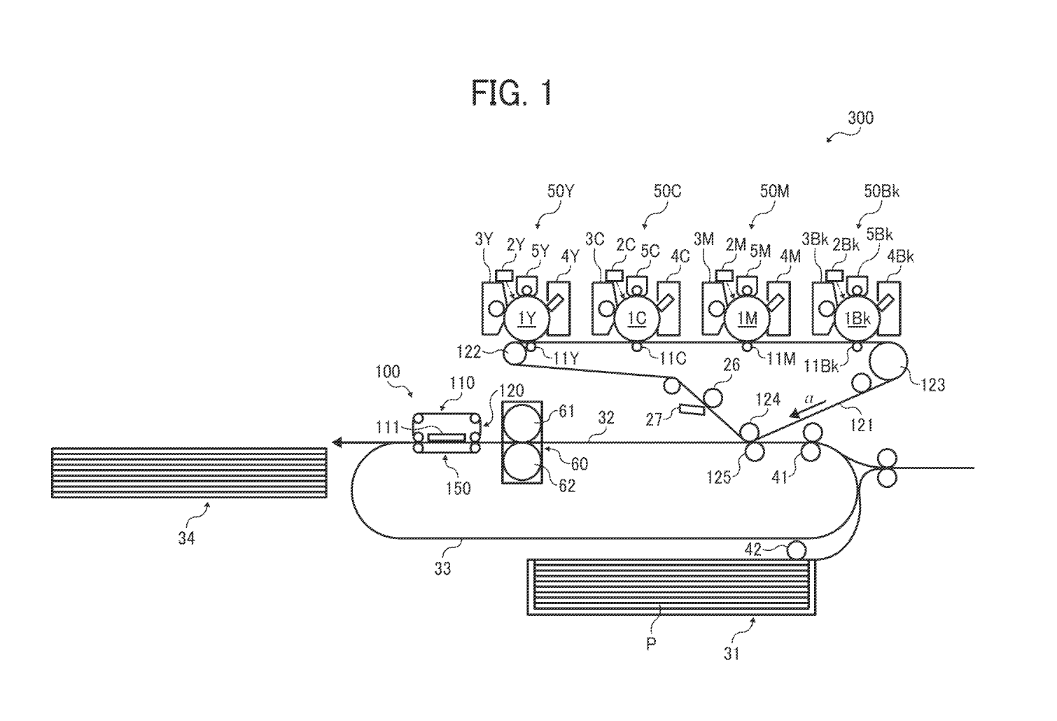

A description is now given of an example of a configuration of an image forming apparatus 300 including a cooling device 100 according to illustrative embodiments. FIG. 1 is a schematic vertical cross-sectional view illustrating an example of a configuration of the image forming apparatus 300. It is to be noted that, in the present specification, the image forming apparatus 300 is a tandem-type full-color printer employing an intermediate transfer belt system.

The image forming apparatus 300 includes an endless belt member, which, in the illustrative embodiments, is an intermediate transfer belt 121 rotatably wound around first, second, and third extension rollers 122, 123, and 124. One of the first, second, and third extension rollers 122, 123, and 124 is rotatively driven by a drive force from a drive motor, not shown, so that the intermediate transfer belt 121 is rotated clockwise in a direction indicated by arrow a in FIG. 1.

The image forming apparatus 300 further includes processing units for image formation disposed around the intermediate transfer belt 121. It is to be noted that suffixes Y, C, M, and Bk hereinafter refer to colors of toner used for image formation, that is, yellow (Y), cyan (C), magenta (M), and black (Bk).

Image forming units 50Y, 50C, 50M, and 50Bk (hereinafter collectively referred to as image forming units 50), each forming a toner image of the specified color, that is, yellow (Y), cyan (C), magenta (M), or black (Bk), are disposed above the intermediate transfer belt 121 between the first and second extension rollers 122 and 123, in that order from upstream to downstream in the direction of rotation of the intermediate transfer belt 121.

The image forming units 50 have the same basic configuration, differing only in the color of toner used. Specifically, the image forming units 50 respectively includes drum-type photoconductors 1Y, 1C, 1M, and 1Bk (hereinafter collectively referred to as photoconductors 1), chargers 5Y, 5C, 5M, and 5Bk (hereinafter collectively referred to as chargers 5), optical writing devices 2Y, 2C, 2M, and 2Bk (hereinafter collectively referred to as optical writing devices 2), developing devices 3Y, 3C, 3M, and 3Bk (hereinafter collectively referred to as developing devices 3), and cleaning devices 4Y, 4C, 4M, and 4Bk (hereinafter collectively referred to as cleaning devices 4). The chargers 5, the optical writing devices 2, the developing devices 3, and the cleaning devices 4 are disposed around the respective photoconductors 1. The image forming units 50 further include primary transfer rollers 11Y, 11C, 11M, and 11Bk (hereinafter collectively referred to as primary transfer rollers 11) disposed opposite the respective photoconductors 1 with the intermediate transfer belt 121 interposed therebetween. The primary transfer rollers 11 primarily transfer toner images formed on the respective photoconductors 1 onto the intermediate transfer belt 121. The image forming units 50 are arranged side by side at predetermined intervals along the direction of rotation of the intermediate transfer belt 121.

Although employing an optical system using an LED as a light source in the present illustrative embodiment, alternatively, the optical writing devices 2 may employ a laser optical system using a semiconductor laser as the light source. The optical writing devices 2 irradiate the respective photoconductors 1 with light based on image data.

The image forming apparatus 300 further includes a sheet tray 31 that accommodates sheets P, a sheet feed roller 42, and a pair of registration rollers 41, all of which are disposed below the intermediate transfer belt 121. A secondary transfer roller 125 that secondarily transfers a toner image from the intermediate transfer belt 121 onto the sheet P is disposed opposite the third extension roller 124, around which the intermediate transfer belt 121 is wound, with the intermediate transfer belt 121 interposed therebetween. A belt cleaning device 27 that cleans the intermediate transfer belt 121 is disposed downstream from the third extension roller 124 and upstream from the first extension rollers 122 in the direction of rotation of the intermediate transfer belt 121 to contact an outer surface of the intermediate transfer belt 121. In addition, an opposing roller 26 is disposed opposite the belt cleaning device 27 with the intermediate transfer belt 121 interposed therebetween.

A sheet conveyance path 32, through which the sheet P is conveyed from the sheet tray 31 to a discharge container 34, extends within the image forming apparatus 300. Within the sheet conveyance path 32, a fixing device 60 is disposed downstream from the secondary transfer roller 125 in a direction of conveyance of the sheet P. The fixing device 60 includes a heat roller 61 having a heat source such as a heater therewithin and a fixing roller 62.

The cooling device 100 that cools the sheet P having a toner image thereon fixed by the fixing device 60 is disposed downstream from the fixing device 60. The discharge container 34, to which the sheet P having the fixed toner image thereon is discharged, is disposed downstream from the cooling device 100.

The image forming apparatus 300 further includes a reverse conveyance path 33 for duplex image formation, in which the sheet P conveyed from the cooling device 100 is reversed and is further conveyed to the pair of registration rollers 41 again when an image is formed also on a back side of the sheet P during duplex image formation.

Taking one of the image forming units 50 as a representative example, image forming processes performed in the image forming apparatus 300 are described in detail below. In the same way as the general electrophotographic method, first, a surface of the photoconductor 1 is evenly charged by the charger 5. The optical writing unit 2 irradiates the charged surface of the photoconductor 1 with light to form an electrostatic latent image on the surface of the photoconductor 1. Then, the developing device 3 develops the electrostatic latent image with toner so that a toner image is formed on the surface of the photoconductor 1. The toner image is then primarily transferred from the surface of the photoconductor 1 onto the intermediate transfer belt 121 by the primary transfer roller 11. Thereafter, the surface of the photoconductor 1 is cleaned by the cleaning device 4. These image forming processes are performed in all the image forming units 50, differing only in the color of toner used.

The developing devices 4 included in the respective image forming units 50 develop electrostatic latent images formed on the surfaces of the photoconductors 1 with toner of the specified colors, so that the toner images of the specified colors are formed on the surfaces of the photoconductors 1, respectively. Thus, a full-color toner image is formed using the four image forming units 50. As described previously, the primary transfer rollers 11 are disposed opposite the respective photoconductors 1 with the intermediate transfer belt 121 interposed therebetween. A transfer bias is applied to each transfer roller 11 by a power source, not shown, so that primary transfer positions are formed between the primary transfer rollers 11 and the intermediate transfer belt 121, respectively.

The toner images formed on the surfaces of the photoconductors 1 are primarily transferred onto the intermediate transfer belt 121 by the transfer bias applied to the primary transfer rollers 11 and are sequentially superimposed one atop the other on the intermediate transfer belt 121. Accordingly, a single full-color toner image is formed on the intermediate transfer belt 121.

The full-color toner image formed on the intermediate transfer belt 121 is then secondarily transferred onto the sheet P by the secondary transfer roller 125 at a secondary transfer position. The intermediate transfer belt 121 is then cleaned by the belt cleaning device 27. A transfer bias is applied to the secondary transfer roller 125 by a power source, not shown, during secondary transfer of the toner image from the intermediate transfer belt 121 onto the sheet P. As a result, a transfer electric field is formed between the secondary transfer roller 125 and the third extension roller 124 with the intermediate transfer belt 121 interposed therebetween. Thus, the full-color toner image formed on the intermediate transfer belt 121 is secondarily transferred onto the sheet P conveyed to the secondary transfer position between the secondary transfer roller 125 and the intermediate transfer belt 121.

After the secondary transfer of the full-color toner image from the intermediate transfer belt 121 onto the sheet P, the sheet P having the full-color toner image thereon is conveyed to the fixing device 60. In the fixing device 60, heat and pressure are applied to the sheet P at a fixing nip between the heat roller 61 and the fixing roller 62 so that the full-color toner image is fixed onto the sheet P. Thus, the full-color image is formed on the sheet P. Thereafter, the sheet P is cooled by the cooling device 100. Accordingly, when the sheet P is stacked in the discharge container 34 after being cooled by the cooling device 100, toner on the sheet P securely hardens and is fixed onto the sheet P, thereby preventing toner blocking.

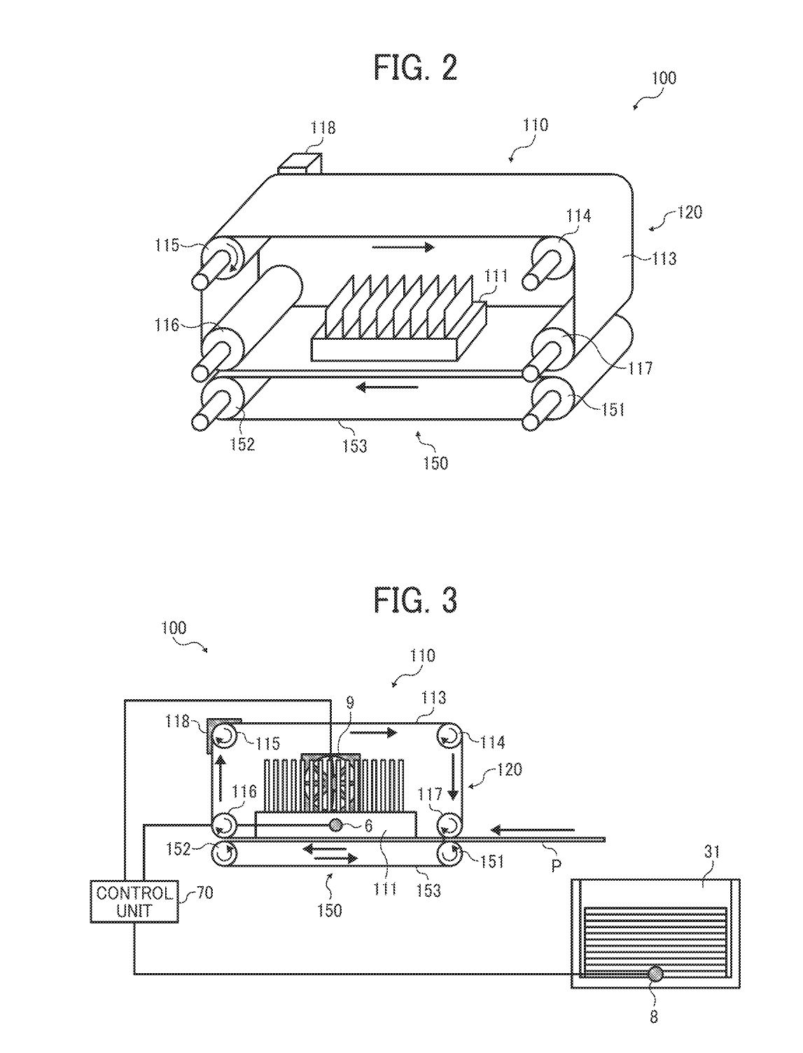

A description is now given of an example of a configuration of the cooling device 100 according to a first illustrative embodiment, with reference to FIG. 2.

FIG. 2 is a perspective view illustrating an example of a configuration of the cooling device 100 according to the first illustrative embodiment. The cooling device 100 includes a conveyance part 120 that conveys the sheet P. In the first illustrative embodiment, the conveyance part 120 is constructed of an upper conveyance unit 110 and a lower conveyance unit 150 parallel thereto.

In the upper conveyance unit 110, an upper conveyance belt 113 that bears the sheet P on an outer surface thereof to convey the sheet P is rotatably wound around multiple extension rollers 114, 115, 116, and 117. The extension roller 115 is a drive roller rotatively driven by a drive force transmitted from a drive motor 118, and the rest of the extension rollers 114, 116, and 117 are driven rollers rotated as the upper conveyance belt 113 rotates. The extension roller 115 is rotated clockwise by the drive motor 118 so that the upper conveyance belt 113 is rotated clockwise in FIG. 2.

A cooling member that cools the sheet P borne on the outer surface of the upper conveyance belt 113, which, in the present illustrative embodiment, is an air-cooling heat sink 111, is disposed inside the loop of the upper conveyance belt 113 in contact with an inner surface of the upper conveyance belt 113.

The lower conveyance unit 150 includes a lower conveyance belt 153 rotatably wound around extension rollers 151 and 152. The lower conveyance belt 153 either directly contacts the upper conveyance belt 113 or indirectly contacts the upper conveyance belt 113 via the sheet P. Accordingly, the lower conveyance belt 153 is rotated counterclockwise in FIG. 2 as the upper conveyance belt 113 rotates.

The sheet P, which is heated and pressed by the fixing device 60 and has a higher temperature after the toner image is fixed thereonto, is sandwiched between and conveyed by the upper conveyance belt 113 of the upper conveyance unit 110 and the lower conveyance belt 153 of the lower conveyance unit 150. When the sheet P thus sandwiched between and conveyed by the upper conveyance belt 113 and the lower conveyance belt 153 reaches an area opposite the air-cooling heat sink 111, the heat of the sheet P is absorbed by the air-cooling heat sink 111 via the upper conveyance belt 113. Accordingly, the sheet P having the fixed toner image thereon is cooled by the air-cooling heat sink 111 via the upper conveyance belt 113 while being conveyed to the discharge container 34. The upper conveyance belt 113 interposed between the air-cooling heat sink 111 and the sheet P prevents a cooling face of the air-cooling heat sink 111 from directly sliding against the sheet P, thereby preventing damage to the toner image fixed onto the sheet P.

FIG. 3 is a schematic view illustrating the cooling device 100 according to the first illustrative embodiment.

As shown in FIG. 3, the cooling device 100 further includes a temperature detector 6 that detects a temperature of the air-cooling heat sink 111. Specifically, the temperature detector 6 contacts the air-cooling heat sink 111 to measure the temperature of the air-cooling heat sink 111. The temperature detector 6 is connected to a control unit 70. The control unit 70 controls the temperature of the air-cooling heat sink 111 by changing an output from a temperature controller, which, in the present illustrative embodiment, is an air-cooling fan 9 connected to the control unit 70, based on the temperature of the air-cooling heat sink 111 detected by the temperature detector 6.

For a fuller appreciation of the non-predictable effects achieved by the above-described illustrative embodiment, a description is now given of a related-art cooling device including a temperature controller that controls a temperature of a cooling member as a comparative example of the present illustrative embodiment.

In general, in the related-art cooling device, a temperature of the sheet P, which is a target to be cooled by the cooling device, is directly measured after the sheet P has passed the fixing device 60. However, it is difficult to directly measure the temperature of the sheet P in a case in which the sheet P is cooled while being conveyed.

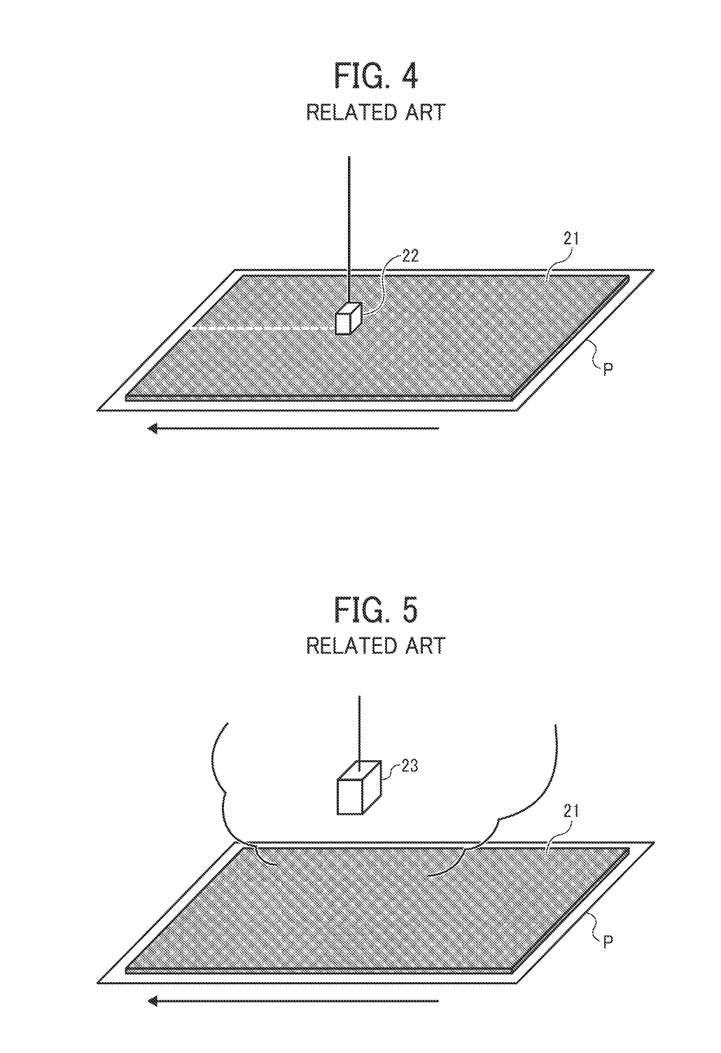

For example, with use of a contact-type temperature detector 22 that contacts the sheet P to measure the temperature of the sheet P during conveyance of the sheet P as illustrated in FIG. 4, friction arises between the temperature detector 22 and the sheet P that damages a toner image 21 fixed onto the sheet P, thereby degrading image quality. In particular, because the sheet P discharged from the fixing device 60 is heated and thus toner of the toner image 21 has not hardened sufficiently, the toner image is more easily damaged.

In another approach, a contactless-type radiation thermometer 23 disposed opposite the sheet P across a predetermined gap is used to measure the temperature of the sheet P as illustrated in FIG. 5. However, evaporation of moisture from the sheet P heated by the fixing device 60 while the sheet P is passing the fixing device 60 can cause an infrared condenser lens of the radiation thermometer 23 to fog, thereby hindering precise measurement of the temperature of the sheet P.

Conceivably, in order to prevent the infrared condenser lens from fogging, a heater that heats the infrared condenser lens in advance may be disposed around the infrared condenser lens, or the infrared condenser lens may be treated with an anti-fogging substance. However, compared to the contact-type temperature detector 22 described above, the radiation thermometer 23 itself is more costly. In addition, special treatment such as the anti-fog treatment further increases production cost. Further, in the case of use of the radiation thermometer 23, a color of the toner image 21 formed on the sheet P and presence or absence of margins on the sheet P may affect infrared radiation emitted from the sheet P having the toner image thereon, thereby hindering precise measurement of the temperature of the sheet P.

To solve these problems, the cooling device 100 according to the present illustrative embodiment detects the temperature of the cooling member, that is, the air-cooling heat sink 111, using the temperature detector 6, so that the temperature of the air-cooling heat sink 111 is controlled based on the result detected by the temperature detector 6.

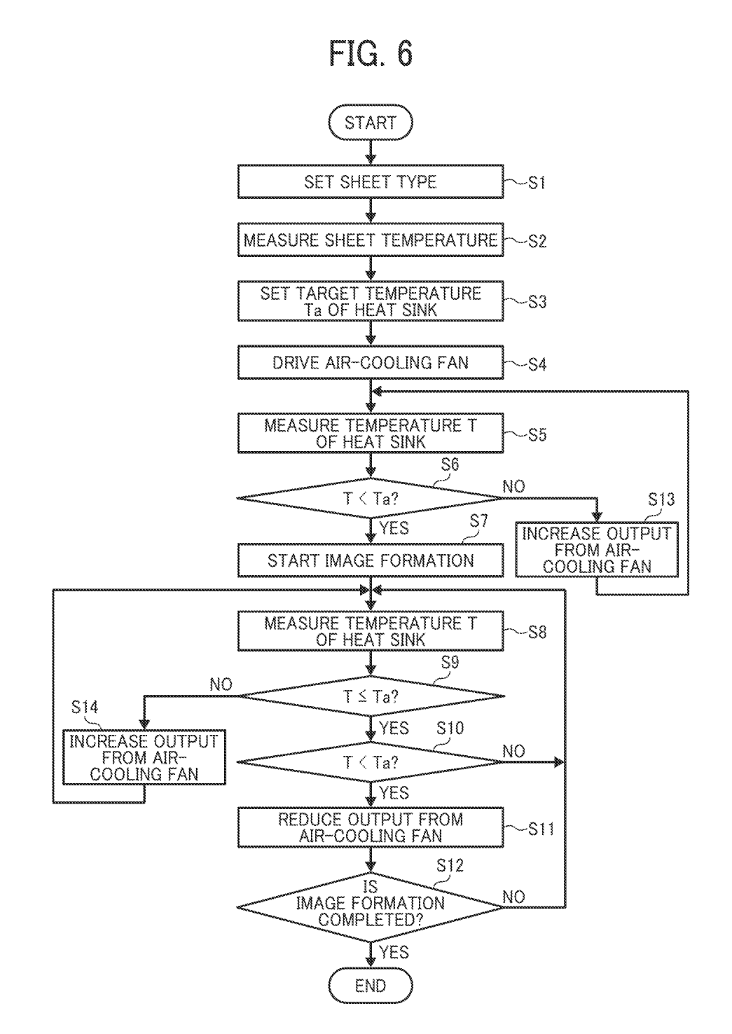

FIG. 6 is a flowchart illustrating steps in a process of controlling the temperature of the air-cooling heat sink 111 according to the first illustrative embodiment.

At step S1, a type of the sheet P to be cooled by the cooling device 100 is set. At step S2, a temperature detector 8 provided to the sheet tray 31 measures a temperature of the sheet P accommodated within the sheet tray 31 before image formation. Based on the temperature thus measured by the temperature detector 8, at step S3 the control unit 70 sets a target temperature Ta [C°] of the air-cooling heat sink 111 according to, for example, conditions shown in Table 1 below.

TABLE 1
Target Temperature Ta [C. °]of Air-Cooling Heat Sink

Temperature of Sheet in Sheet Tray

| Type of Sheet | 0-10 C. ° | 10-20 C. ° | 20-30 C. ° |
|---|---|---|---|
| Sheet of up to 100 gsm | 60 C. ° | 58 C. ° | 56 C. ° |
| Sheet of 100-200 gsm | 58 C. ° | 56 C. ° | 54 C. ° |
| Sheet of 200-300 gsm | 56 C. ° | 54 C. ° | 52 C. ° |

Under conditions that require higher cooling performance, an output from the air-cooling fan 9 is increased to improve heat dissipation performance of the air-cooling heat sink 111. As a result, the air-cooling heat sink 111 with reduced temperature absorbs the heat from the sheet P via the upper conveyance belt 113.

The following two aspects are taken into consideration in setting the conditions shown in Table 1 above.

First, cooling performance required for the cooling device 100 differs depending on the sheet types. For example, cardboard tends to retain heat more than thin paper, and therefore higher cooling performance is needed.

Secondly, even when the same type of sheet P is heated by the fixing device 60 at the same fixing temperature, cooling performance required for the cooling device 100 differs depending on a temperature of the sheet P before heated by the fixing device 60. For example, a sheet P stored under the temperature of 0° C. and a sheet P stored under the temperature of 30° C. have different temperatures even after heated by the fixing device 60 at the same fixing temperature for the same period of time.

The reason for measuring the sheet P accommodated within the sheet tray 31 is that the sheet P, which is not conveyed yet and thus stationary, allows stable and precise measurement of the temperature of the sheet P. Alternatively, the temperature of the sheet P may be measured in the middle of the conveyance path of the sheet P within the image forming apparatus 300. In such a case, to prevent the problems caused by the direct measurement of the temperature of the sheet P described previously, it is preferable that the temperature of the sheet P be measured at a position upstream from the secondary transfer nip in the direction of conveyance of the sheet P.

Further alternatively, the target temperature Ta [C°] of the air-cooling heat sink 111 may be decided in a way other than the conditions shown in Table 1 above. With regard to the types of the sheet P, it is most preferable that the target temperature Ta [C°] of the air-cooling heat sink 111 be specified not only by a thickness of the sheet P but also by brands of the sheet P.

Returning to FIG. 6, after the setting of the target temperature Ta of the air-cooling heat sink 111, at step S4 the air-cooling fan 9 is driven. Thereafter, at step S5 a temperature T of the air-cooling heat sink 111 is measured. At step S6 the control unit 70 determines whether or not the temperature T of the air-cooling heat sink 111 is less than the target temperature Ta. When the temperature T exceeds the target temperature Ta (NO at step S6), the process proceeds to step S13 to increase an output from the air-cooling fan 9, so that the air-cooling heat sink 111 is cooled to have the target temperature Ta or less. Thus, in the present illustrative embodiment, the air-cooling fan 9 functions also as a heat dissipator to dissipate the heat from the cooling member, that is, the air-cooling heat sink 111, thereby facilitating control of the temperature of the cooling member based on a degree of heat dissipation from the cooling member. Thereafter, the temperature T of the air-cooling heat sink 111 is measured again at step S5. By contrast, when the temperature T is less than the target temperature Ta (YES at step S6), the process proceeds to step S7 to start image formation.

At step S8 the temperature T of the air-cooling heat sink 111 is measured as needed. At step S9 the control unit 70 determines whether or not the temperature T of the air-cooling heat sink 111 is equal to or less than the target temperature Ta. When the temperature T exceeds the target temperature Ta (NO at step S9), the process proceeds to step S14 to increase an output from the air-cooling fan 9 such that the air-cooling heat sink 111 has the target temperature Ta. By contrast, when the temperature T is equal to or less than the target temperature Ta (YES at step S9), the process proceeds to step S10 to determine whether or not the temperature T of the air-cooling heat sink 111 is less than the target temperature Ta. When the temperature T of the air-cooling heat sink 111 is less than the target temperature Ta (YES at step S10), the process proceeds to step S11 so that the output from the air-cooling fan 9 is reduced to keep the temperature T of the air-cooling heat sink 111 at the target temperature Ta. Thereafter, at step S12 the control unit 70 determines whether or not image formation is completed. When image formation is completed (YES at step S12), the process of steps is completed. By contrast, when image formation is not completed yet (NO at step S12), the process returns to step S8 to measure the temperature T of the air-cooling heat sink 111, and then the rest of the steps described above is repeated.

It is to be noted that the fixing temperature for fixing the toner image onto the sheet P by the fixing device 60 differs depending on the sheet types as shown in Table 2 below.

TABLE 2

| Type of Sheet | Temperature of Fixing Roller |
|---|---|
| Sheet of up to 100 gsm | 140 C. ° |
| Sheet of 100-200 gsm | 155 C. ° |
| Sheet of 200-300 gsm | 170 C. ° |

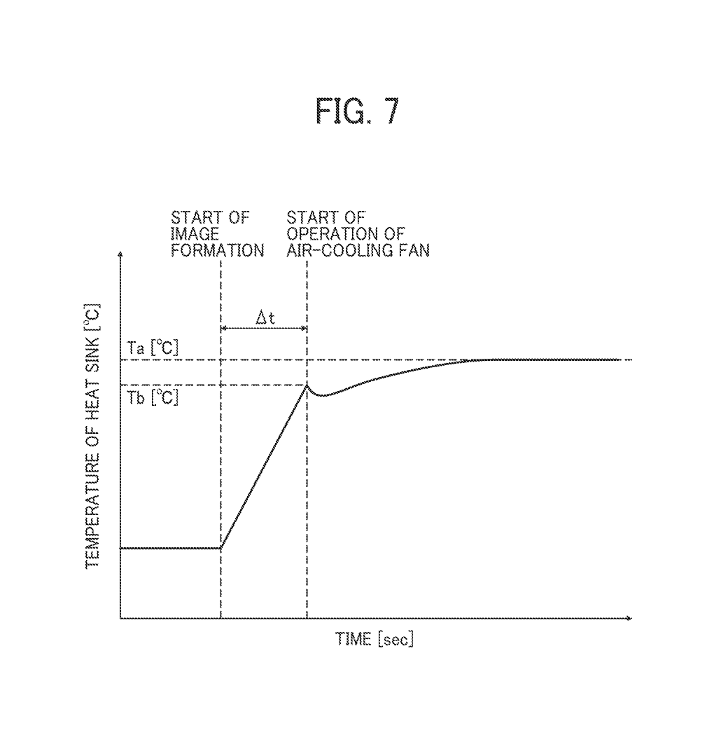

A description is now given of a second illustrative embodiment. FIG. 7 is a graph showing a relation between the temperature of the air-cooling heat sink 111 and an operating time of the image forming apparatus 300. As shown in FIG. 7, when the temperature of the air-cooling heat sink 111 immediately before the start of image formation is less than a threshold temperature Tb [C°], which is equal to or less than the target temperature Ta, image formation is started without driving the air-cooling fan 9, thereby reducing power consumption and noise. Thereafter, when the air-cooling heat sink 111 has the threshold temperature Tb during continuous image formation, the air-cooling fan 9 is driven to control the air-cooling heat sink 111 to have the target temperature Ta.

Such a configuration enables the cooling device 100 to cool the sheet P without driving the air-cooling fan 9 in a case in which an operating time for each image formation is less than Δt shown in FIG. 7.

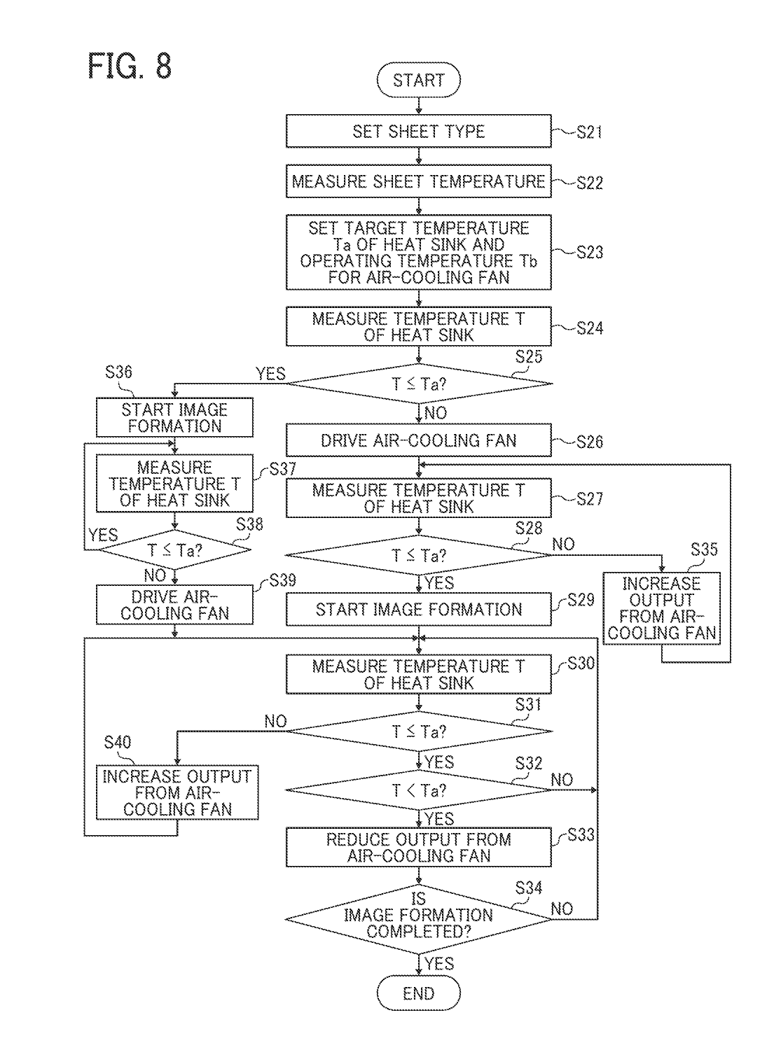

FIG. 8 is a flowchart illustrating steps in a process of controlling the temperature of the air-cooling heat sink 111 according to the second illustrative embodiment.

At step S21, a type of the sheet P to be cooled by the cooling device 100 is set. At step S22, the temperature detector 8 provided to the sheet tray 31 detects a temperature of the sheet P accommodated within the sheet tray 31 before image formation. Based on the temperature thus detected by the temperature detector 8, at step S23 the control unit 70 sets a target temperature Ta [C°] of the air-cooling heat sink 111 according to, for example, the conditions shown in Table 1 above. At the same time, the control unit 70 also sets an operating temperature Tb [C°] for the air-cooling fan 9.

Next, at step S24 the temperature detector 6 measures the temperature T of the air-cooling heat sink 111. At step S25 the control unit 70 determines whether or not the temperature T of the air-cooling heat sink 111 is equal to or less than the target temperature Ta.

When the temperature T exceeds the target temperature Ta (NO at step S25), the process proceeds to step S26 to drive the air-cooling fan 9. Thereafter, at step S27 the temperature detector 6 measures the temperature T of the air-cooling heat sink 111. At step S28 the control unit 70 determines whether or not the temperature T of the air-cooling heat sink 111 thus measured at step S27 is equal to or less than the target temperature Ta. When the temperature T exceeds the target temperature Ta (NO at step S28), the process proceeds to step S35 to increase an output from the air-cooling fan 9. Thus, the air-cooling heat sink 111 is cooled to have the target temperature Ta or less. Thereafter, the temperature T of the air-cooling heat sink 111 is measured again at step S27. By contrast, when the temperature T of the air-cooling heat sink 111 is equal to or less than the target temperature Ta (YES at step S28), the process proceeds to step S29 to start image formation. Then, at step S30 the temperature T of the air-cooling heat sink 111 is measured as needed. At step S31 the control unit 70 determines whether or not the temperature T of the air-cooling heat sink 111 is equal to or less than the target temperature Ta. When the temperature T exceeds the target temperature Ta (NO at step S31), the process proceeds to step S40 to increase an output from the air-cooling fan 9 such that the air-cooling heat sink 111 has the target temperature Ta.

By contrast, when the temperature T is equal to or less than the target temperature Ta (YES at step S31), at step S32 the control unit 70 further determines whether or not the temperature T of the air-cooling heat sink 111 is less than the target temperature Ta. When the temperature T of the air-cooling heat sink 111 is less than the target temperature Ta (YES at step S32), the process proceeds to step S33 so that an output from the air-cooling fan 9 is reduced to keep the temperature T of the air-cooling heat sink 11 at the target temperature Ta. Thereafter, at step S34 the control unit 70 determines whether or not image formation is completed. When image formation is completed (YES at step S34), the process of steps is completed. By contrast, when image formation is not completed yet (NO at step S34), the process returns to step S30 to measure the temperature T of the air-cooling heat sink 111, and then the rest of the steps described above is repeated.

By contrast, when the temperature T of the air-cooling heat sink 111 measured at step S24 is equal to or less than the target temperature Ta (YES at step S25), the process proceeds to step S36 to start image formation without driving the air-cooling fan 9. Next, at step S37 the temperature detector 6 measures the temperature T of the air-cooling heat sink 111. At step S38 the control unit 70 determines whether or not the temperature T of the air-cooling heat sink 111 is equal to or less than the target temperature Ta. When the temperature T exceeds the target temperature Ta (NO at step S38), the process proceeds to step S39 to drive the air-cooling fan 9.

A description is now given of an example of a configuration of the cooling device 100 according to a third illustrative embodiment. The difference from the second illustrative embodiment is that, in place of the air-cooling heat sink 111, a liquid-cooling system is employed as a cooling member in the third illustrative embodiment. Thus, in the third illustrative embodiment, the same reference numerals are used for those components identical to the components according to the foregoing illustrative embodiments, and the descriptions of those components are omitted.

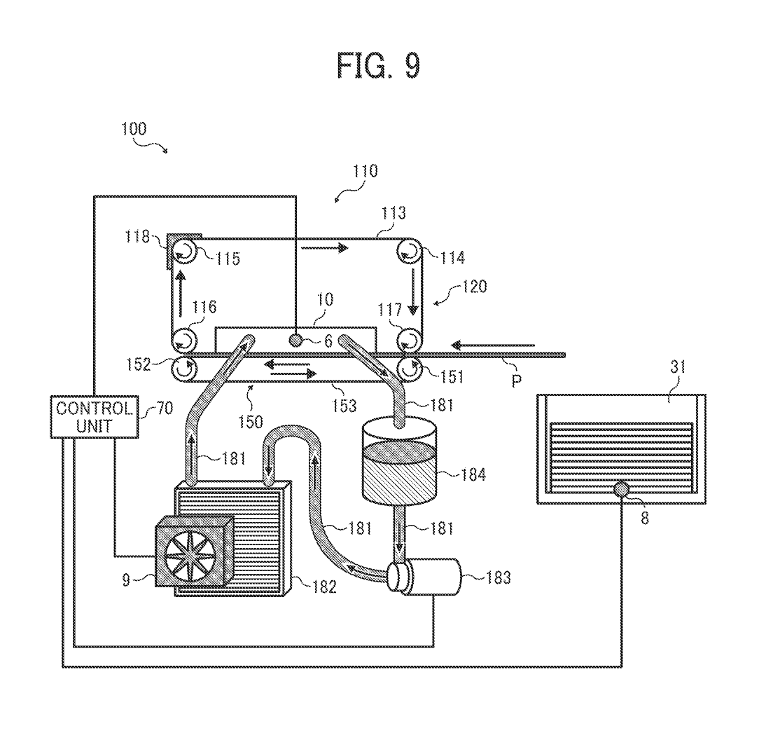

FIG. 9 is a schematic view illustrating an example of a configuration of the cooling device 100 according to the third illustrative embodiment. The cooling device 100 according to the third illustrative embodiment employs the liquid-cooling system, in which a cooling member disposed inside the loop of the upper conveyance belt 113 of the upper conveyance unit 110 to contact the inner surface of the upper conveyance belt 113 has a channel therewithin, through which a liquid coolant flows.

In the third illustrative embodiment, the cooling member is a liquid-cooling plate 10 formed of aluminum. The liquid-cooling plate 10 includes a channel, through which a liquid coolant flows, and cools the sheet P via the upper conveyance belt 113.

A lateral face of the liquid-cooling plate 10 in a width direction of the upper conveyance belt 113 has an inlet and an outlet, to each of which a rubber tube 118 is connected. The cooling device 100 according to the third illustrative embodiment further includes a radiator 182, a coolant conveyance unit, which, in the present illustrative embodiment, is a pump 183, and a tank 184. The radiator 182, the pump 183, and the tank 184 are connected to one another with the tubes 181.

The liquid coolant conveyed from the tank 184 by the pump 183 flows to the radiator 182 to be cooled by the radiator 182. The liquid coolant thus cooled takes heat, which is absorbed by the liquid-cooling plate 10 from the sheet P via the upper conveyance belt 113, from the liquid-cooling plate 10 while flowing through the channel formed within the liquid-cooling plate 10, and then returns back to the tank 184. The radiator 182 includes multiple cooling fins that form a channel, through which the liquid coolant flows. An airflow generated within the image forming apparatus 300 or air generated by natural convection within the image forming apparatus 300 gets between the multiple cooling fins so that the liquid coolant flowing through the radiator 182 is cooled. In the present illustrative embodiment, the air-cooling fan 9 blows cool air onto the radiator 182 to more effectively cool the liquid coolant flowing through the radiator 182, thereby further effectively cooling the sheet P using the liquid-cooling plate 10. Thus, in the third illustrative embodiment, the radiator 182, the tubes 181, the pump 183, and the air-cooling fan 9 together constitute the heat dissipator that dissipates heat from the cooling member, that is, the liquid-cooling plate 10.

It is to be noted that, although the radiator 182, the pump 183, and the tank 184 are disposed in front of the liquid-cooling plate 10 in the example illustrated in FIG. 9, the configuration is not limited thereto. Alternatively, the radiator 182, the pump 183, and the tank 184 may be disposed at any position within the image forming apparatus 300 as long as a channel for the liquid coolant formed by the tubes 181 is not serpentine or excessively long. Accordingly, the radiator 182 may be disposed at any position away from the liquid-cooling plate 10 within the image forming apparatus 300, thereby increasing degree of freedom in design and making the image forming apparatus 300 more compact. Further alternatively, the radiator 182 may be disposed near a radiation fan provided to a housing of the image forming apparatus 300 or other cooling fan so as to eliminate a space for a fan dedicated for the radiator 182 and reduce production cost.

Use of different types of metals for the channel formed within the liquid-cooling plate 10 often causes galvanic corrosion. For example, use of aluminum and copper for the channel may corrode a part of the channel formed of a less noble metal, that is, aluminum. For this reason, it is recommended that the channel formed within the liquid-cooling plate 10 be formed of a single type of metal.

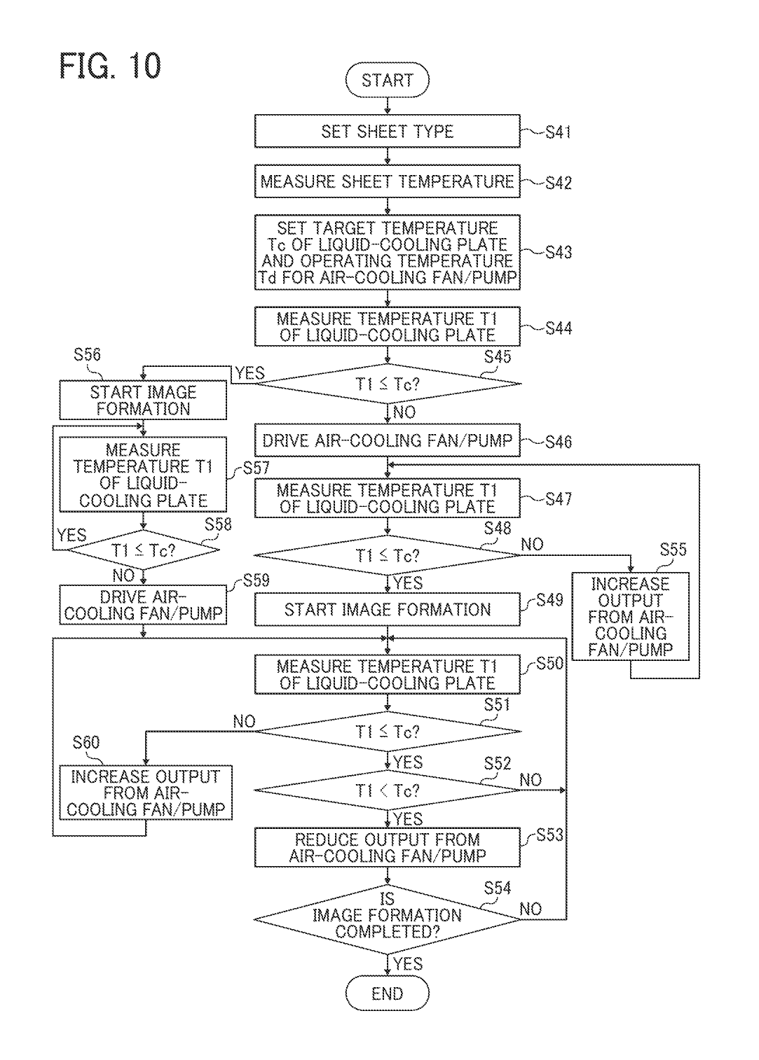

FIG. 10 is a flowchart illustrating steps in a process of controlling a temperature of the liquid-cooling plate 10 according to the third illustrative embodiment. It is to be noted that only the difference from the second illustrative embodiment in the steps of controlling the temperature of the cooling member is that an output from each of the air-cooling fan 9, which is provided for the radiator 182, and the pump 183 is changed, respectively, in the third illustrative embodiment.

At step S41, a type of the sheet P to be cooled by the cooling device 100 is set. At step S42, the temperature detector 8 provided to the sheet tray 31 measures a temperature of the sheet P accommodated within the sheet tray 31 before image formation. Based on the temperature thus measured by the temperature detector 8, at step S43 the control unit 70 sets a target temperature Tc [C°] of the liquid-cooling plate 10 according to, for example, the conditions shown in Table 1 above. At the same time, the control unit 70 also sets an operating temperature Td [C°] for both the air-cooling fan 9 and the pump 183.

Next, at step S44 the temperature detector 6 detects a temperature T1 of the liquid-cooling plate 10. At step S45 the control unit 70 determines whether or not the temperature T1 of the liquid-cooling plate 10 is equal to or less than the target temperature Tc. When the temperature T1 of the liquid-cooling plate 10 exceeds the target temperature Tc (NO at step S45), the process proceeds to step S46 to drive both the air-cooling fan 9 and the pump 183. Thereafter, at step S47 the temperature detector 6 measures the temperature T1 of the liquid-cooling plate 10. At step S48 the control unit 70 determines whether or not the temperature T1 of the liquid-cooling plate 10 is equal to or less than the target temperature Tc. When the temperature T1 of the liquid-cooling plate 10 exceeds the target temperature Tc (NO at step S48), the process proceeds to step S55 to increase an output from each of the air-cooling fan 9 and the pump 183. Thus, the liquid-cooling plate 10 is cooled to have the target temperature Tc or less. Thereafter, the temperature T1 of the liquid-cooling plate 10 is measured again at step S47. By contrast, when the temperature T1 of the air-cooling plate 10 is equal to or less than the target temperature Tc (YES at step S48), the process proceeds to step S49 to start image formation. Then, at step S50 the temperature T1 of the liquid-cooling plate 10 is measured as needed. At step S51 the control unit 70 determines whether or not the temperature T1 of the liquid-cooling plate 10 is equal to or less than the target temperature Tc. When the temperature T1 exceeds the target temperature Tc (NO at step S51), the process proceeds to step S60 to increase an output from each of the air-cooling fan 9 and the pump 183 such that the liquid-cooling plate 10 has the target temperature Tc.

By contrast, when the temperature T1 of the liquid-cooling plate 10 is equal to or less than the target temperature Tc (YES at step S51), at step S52 the control unit 70 further determines whether or not the temperature T1 of the liquid-cooling plate 10 is less than the target temperature Tc. When the temperature T1 of the liquid-cooling plate 10 is less than the target temperature Tc (YES at step S52), the process proceeds to step S53 so that the output from each of the air-cooling fan 9 and the pump 183 is reduced to keep the temperature T1 of the liquid-cooling plate 10 at the target temperature Tc. Thereafter, at step S54 the control unit 70 determines whether or not image formation is completed. When image formation is completed (YES at step S54), the process of steps is completed. By contrast, when image formation is not completed yet (NO at step S54), the process returns to step S50 to measure the temperature T1 of the liquid-cooling plate 10, and then the rest of the steps described above is repeated.

By contrast, when the temperature T1 of the liquid-cooling plate 10 measured at step S44 is equal to or less than the target temperature Tc (YES at step S45), the process proceeds to step S56 to start image formation without driving the air-cooling fan 9 and the pump 183. Next, at step S57 the temperature detector 6 measures the temperature T1 of the liquid-cooling plate 10. At step S58 the control unit 70 determines whether or not the temperature T1 of the liquid-cooling plate 10 is equal to or less than the target temperature Tc. When the temperature T1 of the liquid-cooling plate 10 exceeds the target temperature Tc (NO at step S58), the process proceeds to step S59 to drive both the air-cooling fan 9 and the pump 183.

Employment of the liquid-cooling system in the cooling device 100 allows heat dissipation using the radiator 182. As a result, the sheet P is more efficiently cooled by the cooling device 100 even in cases in which the toner images are fixed onto the sheet P by the fixing device 60 at higher fixing temperature, super thick cardboards are used for image formation, and so on.

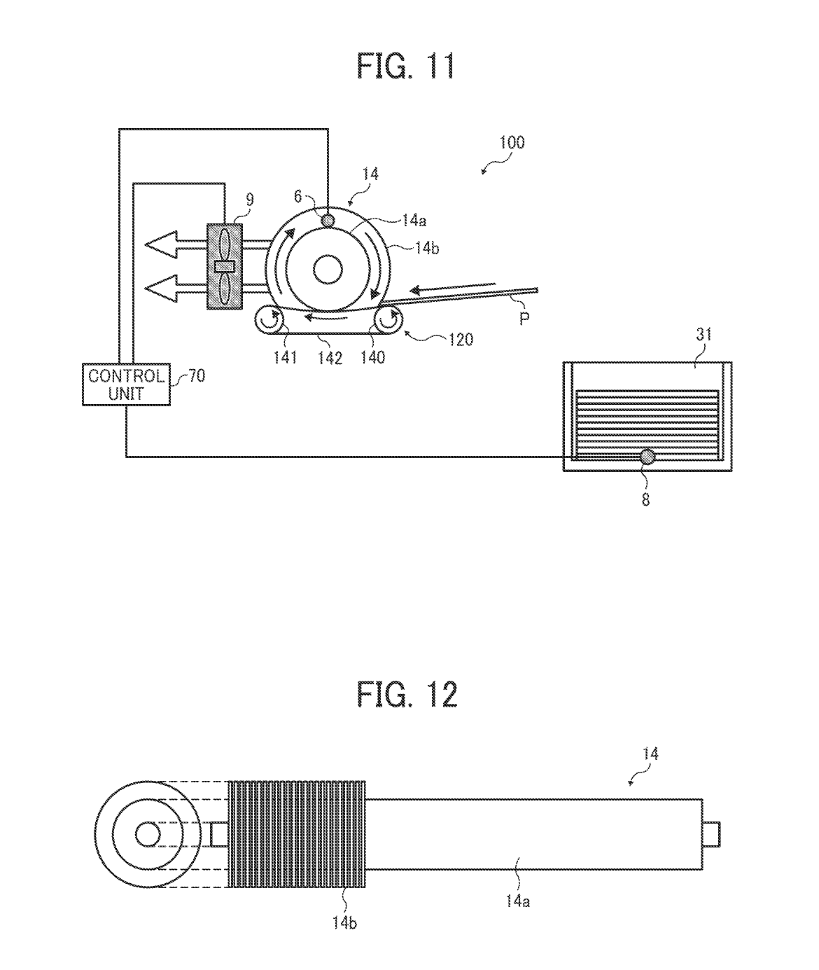

A description is now given of a fourth illustrative embodiment. FIG. 11 is a schematic view illustrating an example of a configuration of the cooling device 100 according to the fourth illustrative embodiment. In the fourth illustrative embodiment, a cooling member included in the cooling device 100 is a heat pipe roller 14 that also conveys the sheet P while cooling the sheet P. It is to be noted that, the rest of the configuration of the fourth illustrative embodiment is substantially the same as the configuration of the second illustrative embodiment described previously.

Specifically, the sheet P, onto which the toner image is fixed by the fixing device 60, is directly contacted and cooled by the heat pipe roller 14, which is rotated to convey the sheet P. The heat pipe roller 14 itself is constructed of a heat pipe 14a and radiation fins 14b as illustrated in FIG. 12.

The cooling device 100 further includes the conveyance part 120. In the fourth illustrative embodiment, the conveyance part 120 is constructed of a conveyance belt 142 wound around extension rollers 140 and 141, which are arranged side by side at an interval in the direction of conveyance of the sheet P. The extension roller 140 is a drive roller driven by a drive force from a drive source, not shown, to rotatively drive the conveyance belt 142. As a result, the conveyance belt 142 is rotated counterclockwise to convey the sheet P from right to left in FIG. 11.

The heat pipe roller 140 is disposed above and pressed against the conveyance belt 142 at a position between the extension rollers 140 and 141 in the direction of conveyance of the sheet P, such that the heat pipe 14a of the heat pipe roller 14 contacts the conveyance belt 142. It is to be noted that the heat pipe roller 14 is rotated as the conveyance belt 142 rotates.

The sheet P heated by the fixing device 60 is conveyed by the conveyance belt 142 and then passes a nip between the heat pipe roller 14 and the conveyance belt 142 while contacting the heat pipe roller 14. At this time, the heat pipe roller 14 absorbs the heat from the sheet P to sufficiently cool the sheet P. The heat pipe roller 14 heated by the heat thus absorbed from the sheet P is then cooled by airflows generated between the radiation fins 14b by the air-cooling fan 9.

In the cooling device 100 according to the fourth illustrative embodiment, the temperature detector 6 that detects the temperature of the heat pipe roller 14 slidably contacts the heat pipe 14a of the heat pipe roller 14. The temperature detector 6 is connected to the control unit 70. The control unit 70 changes the output from the air-cooling fan 9 connected to the control unit 70 based on the temperature of the heat pipe roller 14 detected by the temperature detector 6. Thus, an amount of airflow blowing onto the radiation fins 14b from the air-cooling fan 9 is controlled to control the temperature of the heat pipe roller 14.

Compared to the first to third illustrative embodiments described above in which the sheet P is cooled by the cooling member via the belt, a time in which the sheet P is contacted by the heat pipe roller 14 is shorter in the cooling device 100 according to the fourth illustrative embodiment. However, the heat pipe roller 14 directly contacts the sheet P to absorb the heat from the sheet P, thereby increasing an amount of heat absorption per unit time.

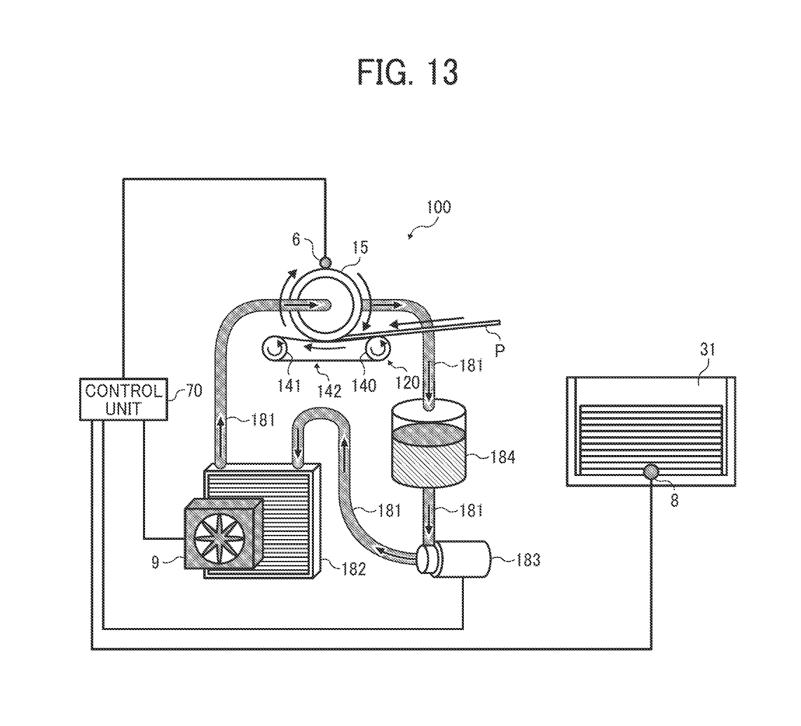

A description is now given of a fifth illustrative embodiment. FIG. 13 is a schematic view illustrating an example of a configuration of the cooling device 100 according to the fifth illustrative embodiment. In the fifth illustrative embodiment, a cooling member included in the cooling device 100 is a liquid-cooling roller 15 that also conveys the sheet P while cooling the sheet P. It is to be noted that the rest of the configuration of the fifth illustrative embodiment is substantially the same as the configuration of the third illustrative embodiment described previously.

Specifically, the sheet P, onto which the toner image is fixed by the fixing device 60, is directly contacted and cooled by the liquid-cooling roller 15 having a channel, through which a liquid coolant flows. The liquid-cooling roller 15 is rotated to convey the sheet P while cooling the sheet P.

The liquid-cooling roller 15 has a tubular structure. The liquid coolant flows through the channel formed within the liquid-cooling roller 15 to cool a surface of the liquid-cooling roller 15. The cooling device 100 including the liquid-cooling roller 15 is disposed immediately downstream from the fixing device 60 in the direction of conveyance of the sheet P. The liquid-cooling roller 15 directly contacts the sheet P to remove the heat from the sheet P while conveying the sheet P, thereby cooling the sheet P.

Similar to the fourth illustrative embodiment, the cooling device 100 according to the fifth illustrative embodiment further includes the conveyance part 120 constructed of the conveyance belt 142 that conveys the sheet P. The conveyance belt 142 is wound around the extension rollers 140 and 141 arranged side by side at an interval in the direction of conveyance of the sheet P. The extension roller 140 is a drive roller driven by a drive force from a drive source, not shown, to rotatively drive the conveyance belt 142. As a result, the conveyance belt 142 is rotated counterclockwise to convey the sheet P from right to left in FIG. 13.

The liquid-cooling roller 15 is disposed above and pressed against the conveyance belt 142 at a position between the extension rollers 140 and 141 in the direction of conveyance of the sheet P to be rotated as the conveyance belt 142 rotates.

Both ends of the liquid-cooling roller 15 in an axial direction have an inlet and an outlet, respectively, to each of which the rubber tube 181 is connected. The cooling device 100 according to the fifth illustrative embodiment further includes the radiator 182, the pump 183, and the tank 184, which are connected to one another with the tubes 181.

The liquid coolant conveyed from the tank 184 by the pump 183 flows to the radiator 182 to be cooled by the radiator 182. The liquid coolant takes heat, which is absorbed by the liquid-cooling roller 15 from the sheet P, from the liquid-cooling roller 15 while flowing through the channel formed within the liquid-cooling roller 15, and then returns back to the tank 184. The radiator 182 includes multiple cooling fins that form a channel, through which the liquid coolant flows. An airflow generated within the image forming apparatus 300 or air generated by natural convection within the image forming apparatus 300 contact between the multiple cooling fins so that the liquid coolant flowing through the radiator 182 is cooled. In the present illustrative embodiment, the air-cooling fan 9 blows cool air onto the radiator 182 to more effectively cool the liquid coolant flowing through the radiator 182, thereby further effectively cooling the sheet P using the liquid-cooling roller 15.

The sheet P heated by the fixing device 60 is conveyed by the conveyance belt 142 and then passes a nip between the liquid-cooling roller 15 and the conveyance belt 142 while contacting the liquid-cooling roller 15. At this time, the liquid-cooling roller 15 absorbs the heat from the sheet P to sufficiently cool the sheet P.

In the cooling device 100 according to the fifth illustrative embodiment, the temperature detector 6 that measures the temperature of the liquid-cooling roller 15 slidably contacts the liquid-cooling roller 15. The temperature detector 6 is connected to the control unit 70. The control unit 70 changes the output from the air-cooling fan 9 and the pump 183, both of which are connected to the control unit 70, based on the temperature of the liquid-cooling roller 15 detected by the temperature detector 6 to control the temperature of the liquid-cooling roller 15.

Compared to the first to third illustrative embodiments described previously, in which the sheet P is cooled by the cooling member via the belt, a time in which the sheet P is contacted by the liquid-cooling roller 15 is shorter in the cooling device 100 according to the fifth illustrative embodiment. However, the liquid-cooling roller 15 directly contacts the sheet P to absorb the heat from the sheet P, thereby increasing an amount of heat absorption per unit time.

Elements and/or features of different illustrative embodiments may be combined with each other and/or substituted for each other within the scope of this disclosure and appended claims.

Illustrative embodiments being thus described, it will be apparent that the same may be varied in many ways. Such exemplary variations are not to be regarded as a departure from the scope of the present invention, and all such modifications as would be obvious to one skilled in the art are intended to be included within the scope of the following claims.

The number of constituent elements and their locations, shapes, and so forth are not limited to any of the structure for performing the methodology illustrated in the drawings.

What is claimed is:

1. A cooling device for use in an image forming apparatus, disposed downstream within the apparatus in a direction of conveyance of a sheet from a fixing device that fixes an image onto the sheet at a temperature corresponding to a sheet type, the cooling device comprising:
a conveyance part to convey the sheet;
a cooling member to absorb heat by thermal conduction from the sheet being conveyed by the conveyance part;
a temperature controller to control a temperature of the cooling member;
a temperature detector to detect the temperature of the cooling member; and
a control unit connected to the temperature controller and the temperature detector,
the control unit controlling the cooling member, using the temperature controller, to a target temperature corresponding to the sheet type based on the temperature of the cooling member detected by the temperature detector.

2. The cooling device according to claim 1, wherein the temperature controller includes a heat dissipator to dissipate heat from the cooling member.

3. The cooling device according to claim 2, wherein the heat dissipator includes a fan to blow air onto the cooling member.

4. The cooling device according to claim 2, wherein the cooling member has a channel formed therewithin, through which a coolant flows,
wherein the heat dissipator comprises:
a radiator to dissipate heat to air;
a tube to circulate the coolant between the cooling member and the heat dissipator;
a coolant conveyance unit to convey the coolant through the tube; and
a fan to blow air onto the radiator,
wherein the control unit changes an output from each of the coolant conveyance unit and the fan to control the cooling member to the target temperature.

5. The cooling device according to claim 2, further comprising a second temperature detector to detect a temperature of a sheet before the image is formed on the sheet by an image forming unit included in the image forming apparatus,
wherein the control unit changes the target temperature based on the temperature of the sheet detected by the second temperature detector.

6. The cooling device according to claim 5, wherein the control unit controls the heat dissipator not to operate when the temperature of the cooling member is equal to or less than the target temperature upon start of image formation by the image forming unit.

7. The cooling device according to claim 1, wherein:
the conveyance part comprises two parallel endless belts, each of which is wound around multiple rollers to be rotated, to sandwich the sheet on opposite sides of the sheet to convey the sheet; and
a cooling face of the cooling member contacts an inner surface of at least one of the two endless belts.

8. The cooling device according to claim 7, wherein the cooling member absorbs the heat from the sheet via the conveyance part.

9. The cooling device according to claim 1, wherein:
the conveyance part comprises an endless belt rotatably wound around multiple rollers to bear the sheet on an outer surface thereof to convey the sheet; and
a cooling face of the cooling member contacts the outer surface of the endless belt.

10. An image forming apparatus, comprising:
an image forming unit to form a toner image on a sheet;
a fixing device to fix the toner image onto the sheet using at least heat; and
a cooling device disposed downstream from the fixing device in a direction of conveyance of the sheet to cool the sheet having the toner image fixed thereonto by the fixing device, the cooling device comprising:
a conveyance part to convey the sheet;
a cooling member to absorb heat by thermal conduction from the sheet being conveyed by the conveyance part;
a temperature controller to control a temperature of the cooling member;
a temperature detector to detect the temperature of the cooling member; and
a control unit connected to the temperature controller and the temperature detector to control the cooling member, using the temperature controller, to a target temperature corresponding to a sheet type based on the temperature of the cooling member detected by the temperature detector.

11. A method of cooling a sheet in an image forming apparatus, the method comprising steps of:
conveying a sheet having an image fixed thereonto at a temperature corresponding to a sheet type;
absorbing heat, using a cooling member, from the sheet being conveyed;
controlling a temperature of the cooling member;
detecting the temperature of the cooling member; and
controlling the cooling member to a target temperature corresponding to the sheet type based on the temperature of the cooling member detected by the detecting.
